(19) United States
(12) Patent Application Publication
(10) Pub. No.: US 2026/0105349 A1
(43) Pub. Date: Apr. 16, 2026

(54) AUTOMATED TRAINING DATA SELECTION

(71) Applicant: Baker Hughes Holdings LLC, Houston, TX (US)

(72) Inventors: Ahmed Faraz Ansari, Maharashtra (IN); Rohan Banerjee, West Bengal (IN); Somesh Chatterjee, Maharashtra (IN); Indu Kaladhar Polepeddy, Telangana (IN); Sahil Ratnakumar Gandhi, Dubai (AE); Shamika Khanolkar, Mumbai (IN)

(21) Appl. No.: 18/912,247

(22) Filed: Oct. 10, 2024

(51) Int. Cl. G06N 20/00

(52) U.S. Cl. CPC G06N 20/00

(57) ABSTRACT

A first set of data, characterizing an operating parameter of an industrial mechanical asset, is received. Identifying and removing values indicative of transients within the first set of data are identified and removed to produce a second set of data characterizing a steady-state operating parameter of the industrial mechanical asset. The second set of data is provided to a predictive model.

### TECHNICAL FIELD

The subject matter described herein relates to selecting data for training a model.

### BACKGROUND

Steady state anomaly detection models require training. Models trained with bad data produce bad results, garbage in-garbage out. It is a tedious task to go through years and years worth of historical data and find good data for training models manually. Even when performing the training data selection manually, it is difficult to filter out every spike, every transient in data. When analytic needs to be applied at hundreds of assets, the total effort and time required becomes huge.

### SUMMARY

This disclosure relates to automated training data selection.

An example implementation of the subject matter described within this disclosure is a method with the following features. A first set of data, characterizing an operating parameter of an industrial mechanical asset, is received. Identifying and removing values indicative of transients within the first set of data are identified and removed to produce a second set of data characterizing a steady-state operating parameter of the industrial mechanical asset. The second set of data is provided to a predictive model.

The disclosed method can be implemented in a variety of ways. For example, within a system that includes at least one data processor and a non-transitory memory storing instructions for the processor to perform aspects of the method. Alternatively or in addition, the method can be in included non-transitory computer readable memory storing the method as instructions which, when executed by at least one data processor forming part of at least one computing system, causes the at least one data processor to perform operations of the method:

Aspects of the example method, that can be combined with the example method alone or in combination with other methods, can include the following. Identifying and removing values indicative of transients include the following steps. A state of the mechanical industrial asset over a time period matching the first set of data is identified. Transient values within the first set of data, indicative of a state change, are identified. The identified values indicative of transients are removed.

Aspects of the example method, that can be combined with the example method alone or in combination with other methods, can include the following. Values within the first set of data that correspond to a shut-down state are identified. The identified values from the first set of data are removed.

Aspects of the example method, that can be combined with the example method alone or in combination with other methods, can include the following. The second set of data is received by the predictive model. Health of the industrial mechanical asset is predicted based upon the predictive model.

Aspects of the example method, that can be combined with the example method alone or in combination with other methods, can include the following. Identifying and removing values indicative of transients can include the following steps. The first set of data is normalized. The first set of data is smoothed. A lagged version of the first set of data is created. The lagged version has a time-offset in comparison to the first set of data. A percentage change between the first set of data and the lagged version is calculated. Values within the first set of data are clustered into clusters based on the calculated percentage change between the first set of data and the lagged version. Clusters that include transient values are identified based on the percentage change exceeding a specified threshold.

Aspects of the example method, that can be combined with the example method alone or in combination with other methods, can include the following. A silhouette score for each cluster is determined. A number of steady states is determined based upon the determined silhouette scores.

Aspects of the example method, that can be combined with the example method alone or in combination with other methods, can include the following. Providing the second set of data to a predictive model includes training the predictive model with the second set of data.

The solution is a workflow that automates the process of training data selection for steady state anomaly detection models. The auto training data selection preprocesses the data, fills gaps, handles data issues, identifies all operating states of the data and selects good data from all states. The workflow guides the user through a series of steps, starting from historical range selection, followed by plots that highlight recommendations for users. If users disagree with the selection, they are allowed to modify the recommendations. The workflow concludes with user confirmation, the selected data is stored and processed for training steady state anomaly detection models.

### BRIEF DESCRIPTION OF DRAWINGS

These and other features will be more readily understood from the following detailed description taken in conjunction with the accompanying drawings.

FIG. 1 is a flowchart of an example method that can be used with aspects of this disclosure;

FIGS. 2A-2D illustrate a flowchart of an example method that can be used in combination with the method illustrated in FIG. 1;

FIGS. 3A-3B illustrate a flowchart of an example method that can be used in combination with the method illustrated in FIG. 2;

FIG. 4 is a chart illustrating raw data indicative of an operating parameter of an industrial mechanical asset;

FIG. 5 is a chart illustrating resulting data after the data illustrated in FIG. 4 is subjected to the method of FIG. 1;

FIG. 6 is an example user interface that can be used with aspects of this disclosure; and

FIG. 7 is a block diagram of an example controller that can be used with aspects of this disclosure.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

While predictive models are often used to assess the health of industrial assets within a plant, they are limited by the data with which they are trained. For example, spurious trips, transients, ramp-up spikes, and other transitory states can cause such models to accept wider operating ranges than are truly valid for steady state operation. Such issues are sometimes colloquially referred to as “garbage in, garbage out”. Manually removing such noisy data can be labor intensive, inconsistent, and time consuming.

This disclosure relates to automated training data selection for the efficient preparation of steady-state anomaly detection and predictive models. This automated process can be used to identify and rectify spikes and transients, as well as gain insights into asset operating states. The subject matter described herein can also generate suitable time durations of data for training steady-state anomaly detection models. The subject matter involves selecting assets for analytics, running analytics for each asset, utilizing historical data for training data selection (TDS). For simplicity, the subject matter described herein is described with a single set of data received from a single, industrial, mechanical asset; however, it should be noted that such subject matter can be scaled to encompass multiple sets of data, data streams, industrial assets, and/or plants (on the order of hundreds or thousands for each) without departing from this disclosure.

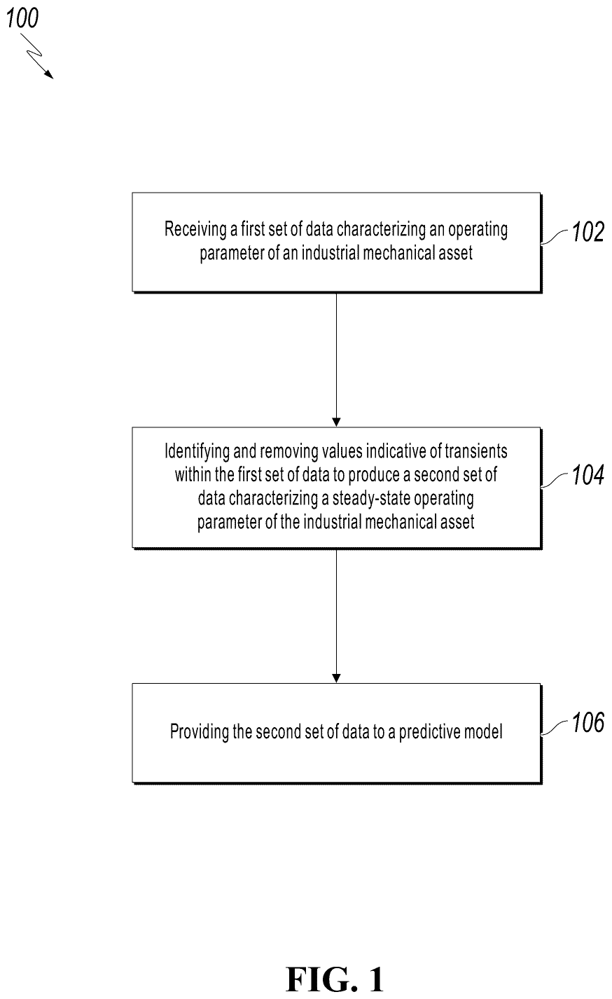

FIG. 1 is a flowchart of an example method 100 that can be used with aspects of this disclosure. In some implementations, all or part of the method 100 can be performed by a controller or similar computing device, an example of which is described later within this disclosure. At 102, a first set of data, characterizing an operating parameter of an industrial mechanical asset, is received. Such data can be indicative of flow-rates, pressures, vibrations, or any other parameter valuable to determining an operating health of the industrial mechanical asset.

At 104, values indicative of transients within the first set of data are identified and removed to produce a second set of data characterizing a steady-state operating parameter of the industrial mechanical asset. For example, in some implementations, such a step can involve identifying a state of the industrial mechanical asset over a time period matching the first set of data. For example, if the first set of data characterizes parameters of the industrial mechanical asset over a period of 24 hours, then a state of the industrial mechanical asset can be identified over the same 24 hour period. Transient values often occur when a state of the industrial mechanical asset changes, for example, during start-up or during a plant process change. Such transient values, which can be indicative of such a state change, can then be identified within the first set of data. These identified values indicative of the transients can then be removed.

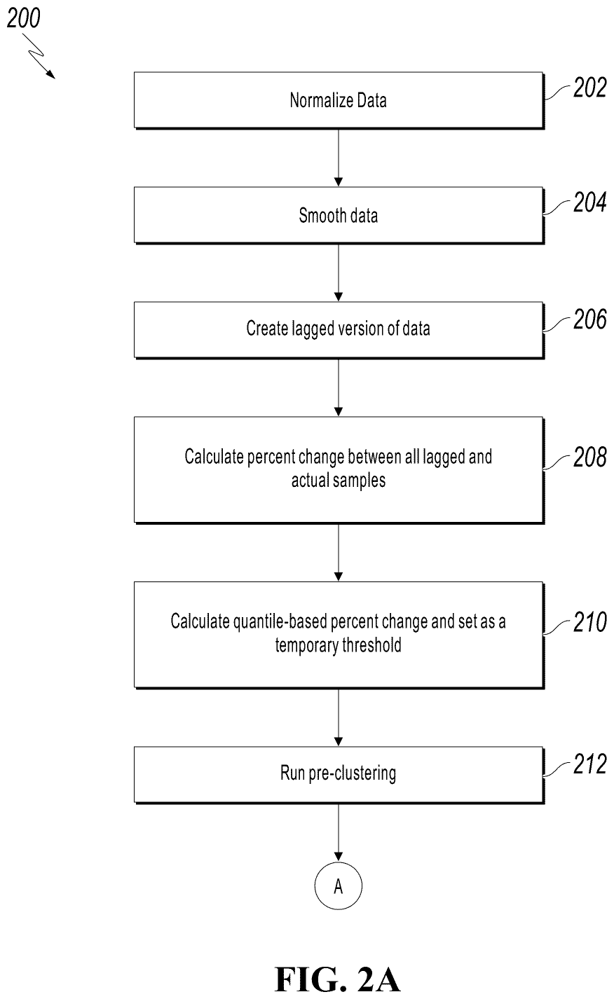

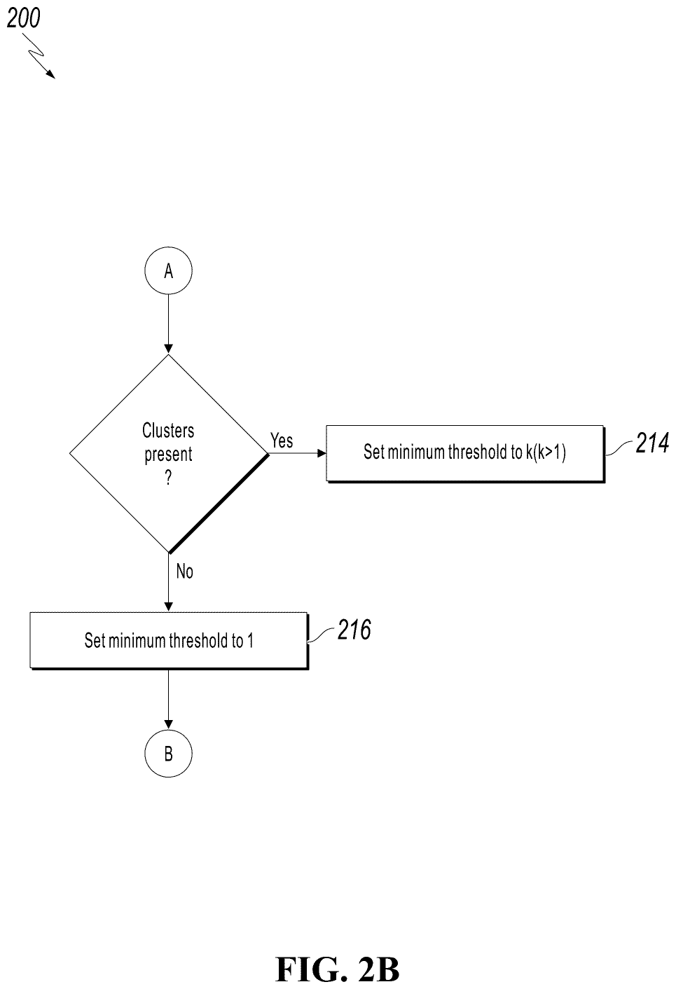

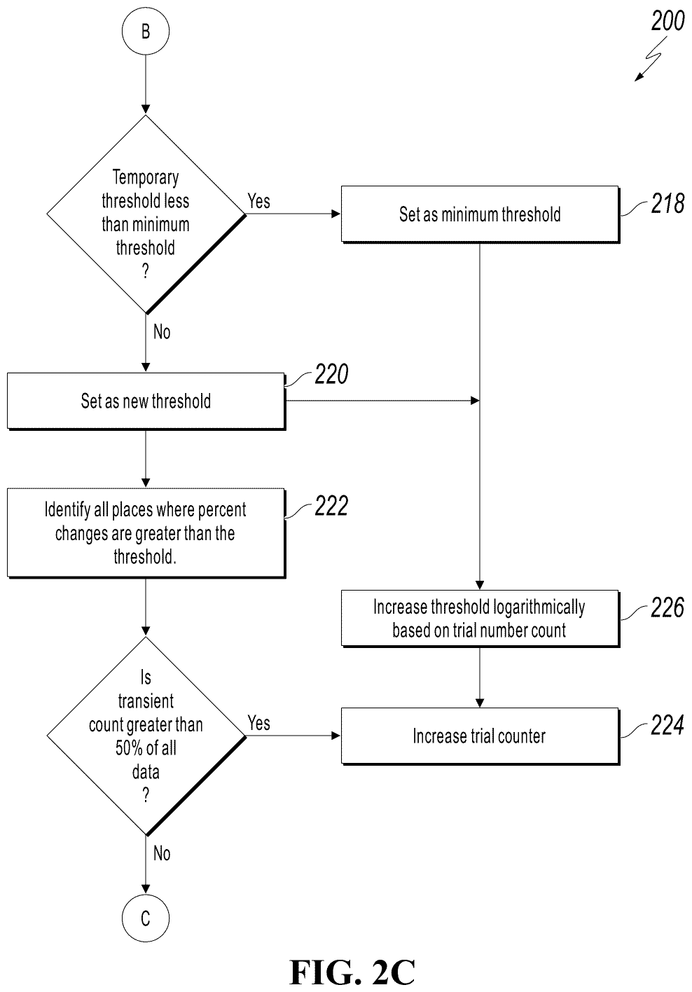

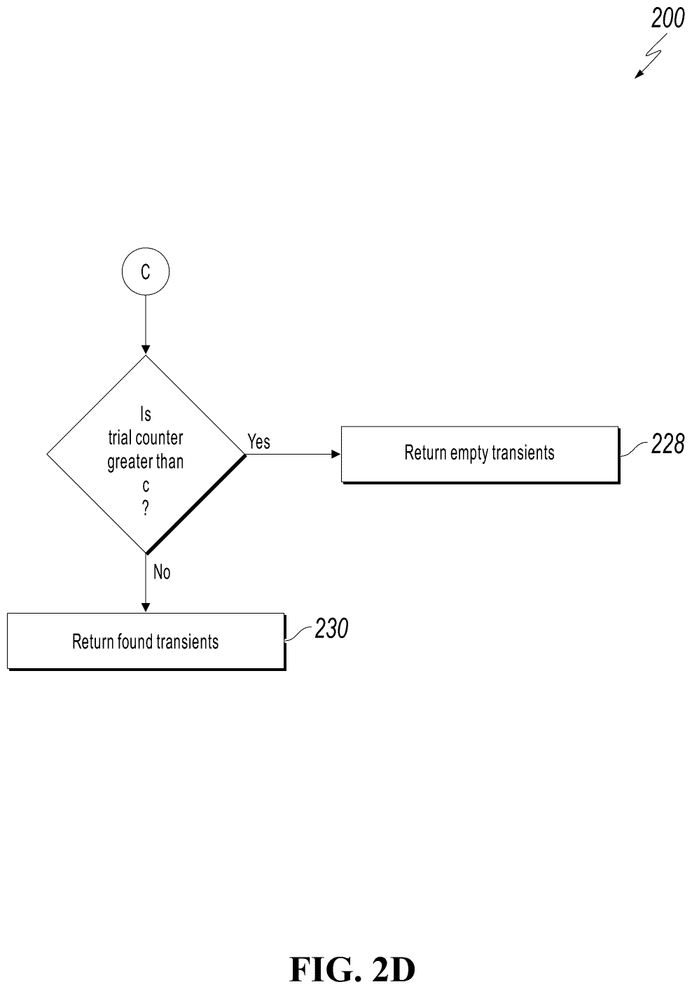

Alternatively or in addition, other processes, methods, or algorithms can be used, such an example method 200 is illustrated in FIGS. 2A-2D. At 202, the first set of data can be normalized. That is, the values within the first set of data can be divided by the greatest value within the first set of data to produce values between 0 and 1. The normalized first set of data can then be smoothed, at 204, for example, by using a moving average. At 206, a lagged version of the first set of data is then be created. The lagged version has a time-offset in comparison to the first set of data. For example, in instances where the first set of data includes values taken every minute, the lagged version may be offset by one minute. Alternatively or in addition, the lagged version may be a number of samples removed from the first set of data, for example, by twenty samples or so. A sample rate and an offset between the first set of data and the lagged set of data can be changed depending upon the type of measurement the data characterizes. At 208, a percentage change between the first set of data and the lagged version can then be calculated. Such a percentage change is calculated by finding a different between the first set of data and the lagged data, and dividing the difference by the first set of data. The percentage change is then, at 210, used to calculate an absolute quantile of present change, and the determined quantile is used as a temporary threshold for the following operations.

At 212, values within the first set of data are then sorted, or clustered, into clusters based on the determined threshold. Pre-clustering can be done by resampling the data over a desired time duration, for example, sixty seconds. In some implementations, the pre-clustering is done with minibatch k-means. In some implementations, the pre-clustering is run for a specified number range of clusters. In the event that pre-clustering results in identifiable clusters, at 214, a minimum threshold of ten clusters is then set. That is, the clustering algorithm will sort the data into at least ten separate clusters. In the event that pre-clustering does not result in identifiable clusters, at 216, a minimum threshold of one cluster is set. Clusters that include transient values can then be identified based on the percentage change exceeding the temporary threshold previously described in relation to percentage change. A value of such a threshold is dependent upon the information characterized by the data.

In some implementations, a minimum threshold regarding percentage change is set. In such implementations, when the temporary threshold is less than the minimum threshold, at 218, then the minimum threshold is used to create a new threshold at 220. In instances when the temporary threshold is not less than the minimum threshold, then the temporary threshold is set as the new threshold at 220. Regardless of what the new threshold is set to, at 222, parts of the data where a percentage change is greater than the new threshold are then identified. If more than 50% of the data is identified at as a transient, then, at 224, a trial counter is increased, for example, logarithmically as shown at 226. In such an example, if ten samples were previously used, then the sample rate is increased to one hundred. The threshold is then appropriately set and parts of the data where a percentage change is greater than the new threshold are once more identified. This loop continues until the transient count is equal to or less than 50% of the data or an outside user ceases the operation. If the trial counter is greater than a specified amount “c”, then empty transients (meaning no transients are found) are returned at 228. If the trial counter is less than a specified amount “c”, then the found transients are returned at 230.

Alternatively or in addition, further pruning of values can occur, for example, by removing values taken during a period of time in which the industrial mechanical asset is shut down. In such a scenario, values within the first set of data that correspond to a shut-down state are identified, then the identified values are removed from the first dataset.

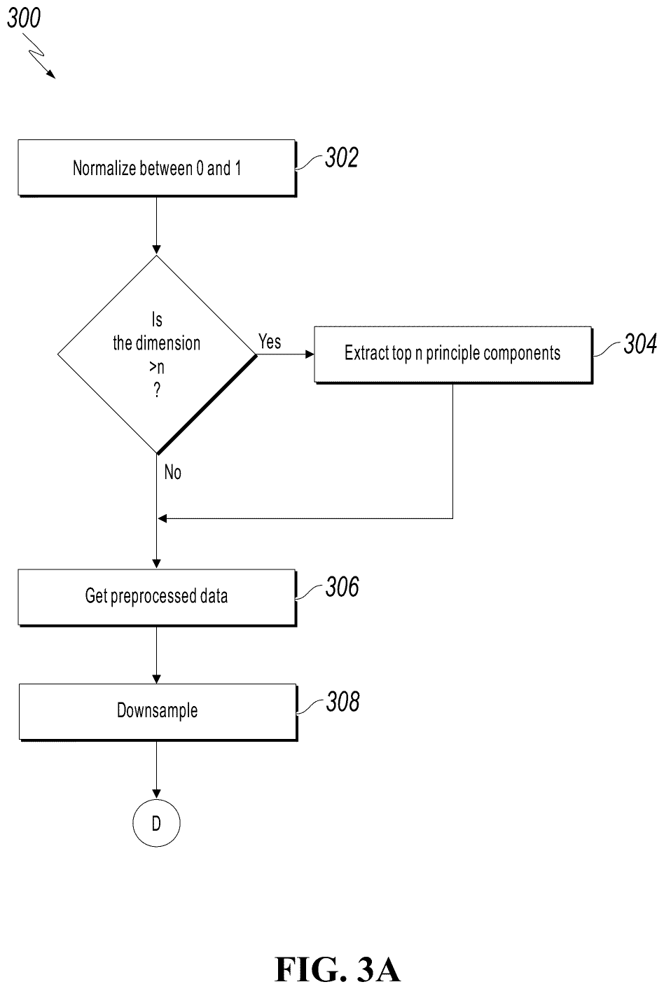

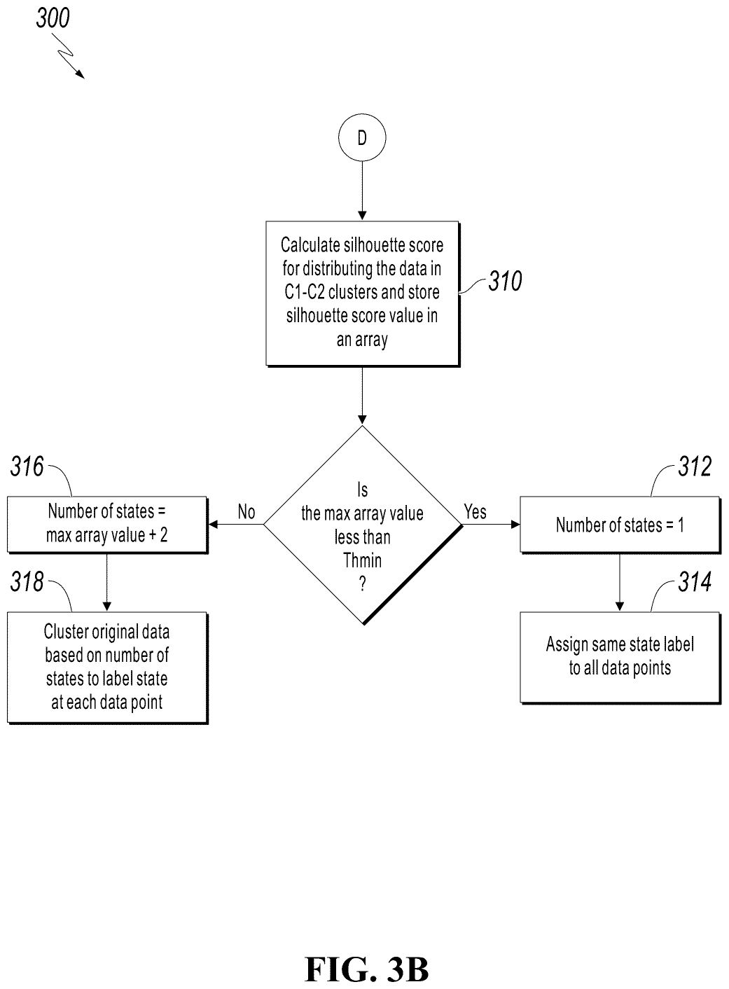

Alternatively or in addition, a number of steady-state operating modes can be determined, for example by determining a silhouette score for each cluster. FIG. 3 illustrates such a method 300. At 302, the data is normalized to values between zero and 1 to produce normalized data. This is accomplished by dividing the values within the data by the highest value within the data. The dimensionality of the data is then determined. In cases where the normalized data includes more than a specified number of principle components “n”, at 304, then the top “n” principle components are extracted from the data, and the “n” principle components are preprocessed at 306. In some instances when there are “n” or less principle components, then the data can optionally be sent directly to preprocessing. In some implementations, a length of the data is determined during preprocessing. After preprocessing, at 308, the data is down-sampled. Down-sampling the data reduces a computational load while determining steady-state operating modes. In some implementations, the data length is reduced by a reduction factor during down-sampling, for example, by a factor of about 20 to 30 times when compared to non-downsampled data. In some implementations, down-sampling is done after applying an anti-aliasing filter, for example, an 8th order anti-aliasing Chebyshev filter. At 310, a silhouette score is calculated to distribute the down-sampled data into clusters a range of clusters (C1-C2) and store a resulting silhouette score in an array. If a maximum value within the array is less than or equal to a specified value “Thmin”, then, at 312, a total number of operating states is assumed to be one. As there is only one operating state, a same state label is applied to all data points within the original data at 314. In instances where the maximum value within the array is greater than the specified value “Thmin”, then the number of array states is determined to be equal to the max array value plus two at 316. The original data is then clustered based on the number of states and each state is labeled at 318. In some implementations, a maximum number of allowed operating states can be set, for example, ten operating states.

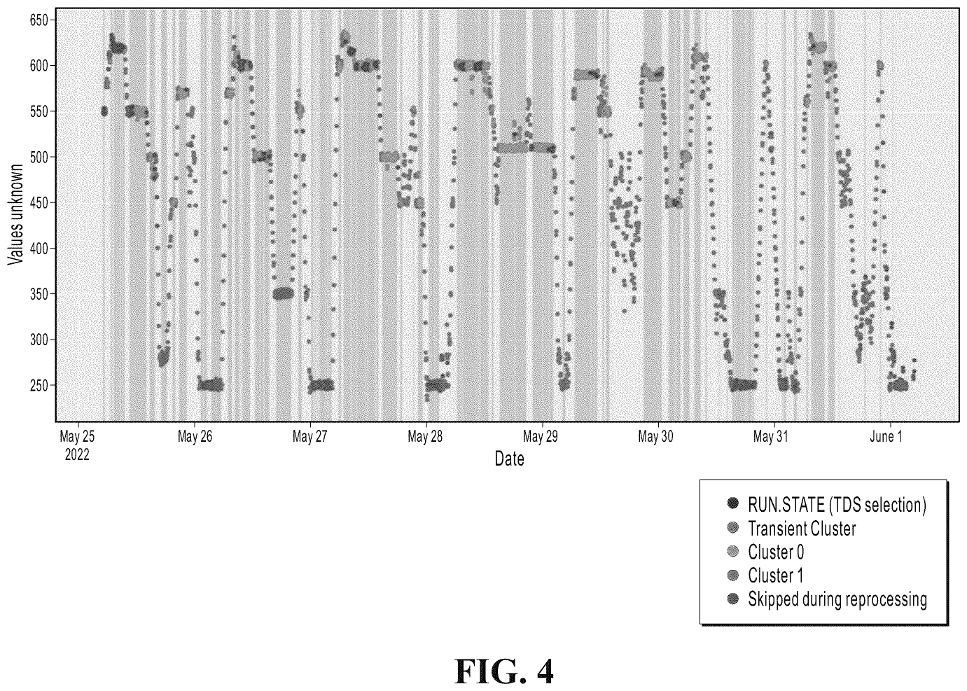

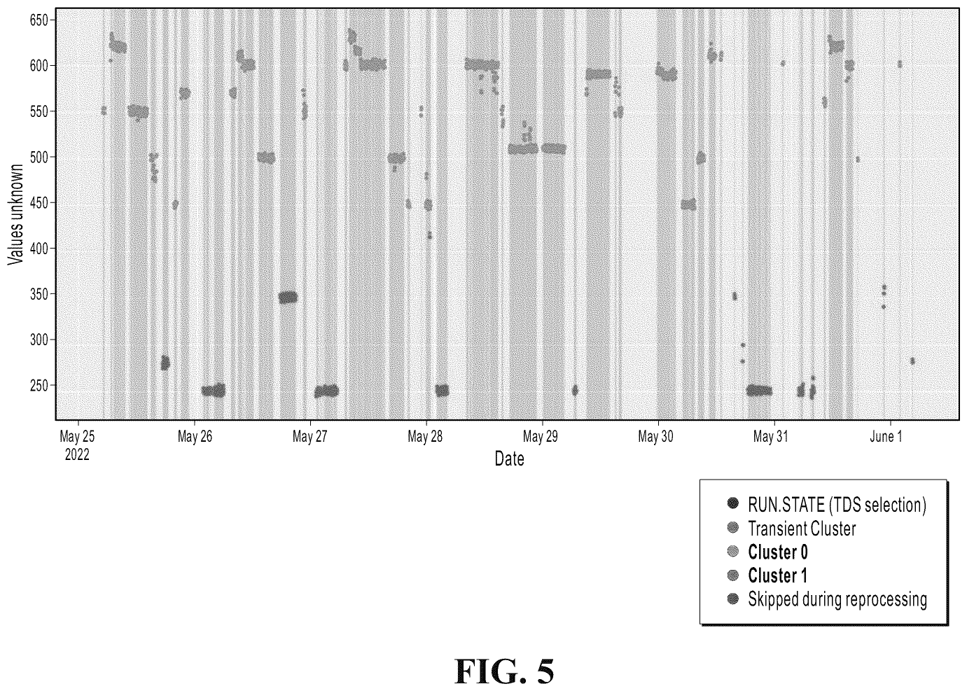

FIG. 4 is a chart illustrating raw data indicative of an operating parameter of an industrial mechanical asset, and FIG. 5 is a chart illustrating resulting data after the data illustrated in FIG. 4 is subjected to the method of FIG. 1. As can be seen in FIG. 4, the raw, filtered first set of data has many spikes and transients to be removed prior to using any of the data for training. Moving on to FIG. 5, such transients and spikes have been removed to produce the displayed second set of data.

At 106, this second set of data is then provided to a predictive model. In some implementations, providing the second set of data to the predictive model includes training the predictive model, at least in part, with the second set of data. Alternatively or in addition, for example, in instances that the predictive model is already trained, the health of the industrial mechanical asset can be predicted by the predictive model based on the second set of data. Such determinations can be made at a larger scale, for example, plant health can be determined based on multiple sets of data. Similarly, multiple sets of data can be processed for a single industrial mechanical asset to make such predictions. Further examples of such implementations are described in published US Patent Application 2024/0125675 filed on Oct. 6, 2023, entitled “ANOMALY DETECTION FOR INDUSTRIAL ASSETS”, the entirety of which is hereby incorporated by reference.

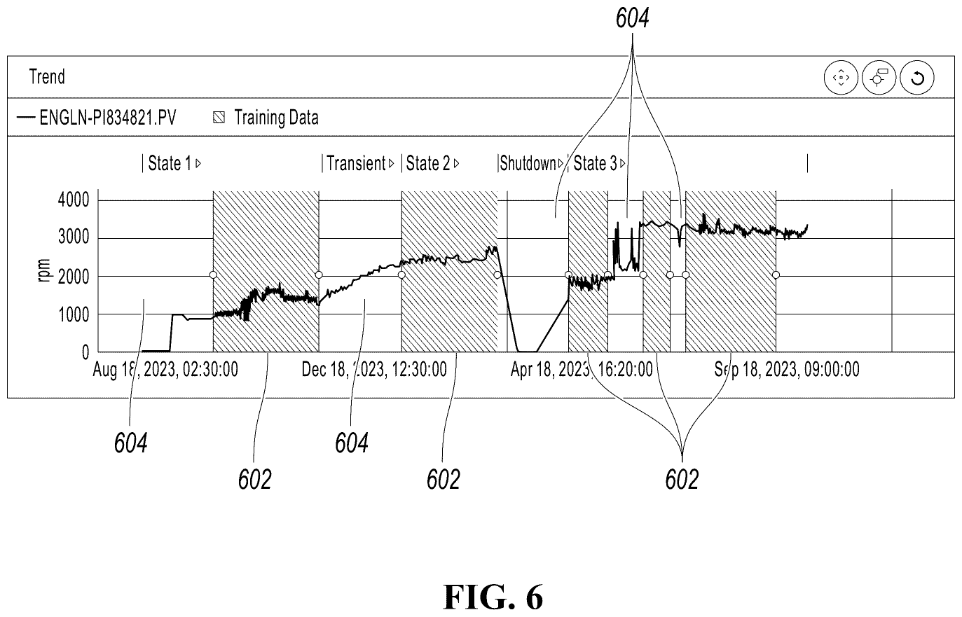

Example results are shown in FIG. 6, which illustrates an example user interface that can be used with aspects of this disclosure. Determined states are illustrated in the shaded regions 602 while transients and shutdowns are shown in the unshaded areas 604. The shaded areas 602 are used for training data.

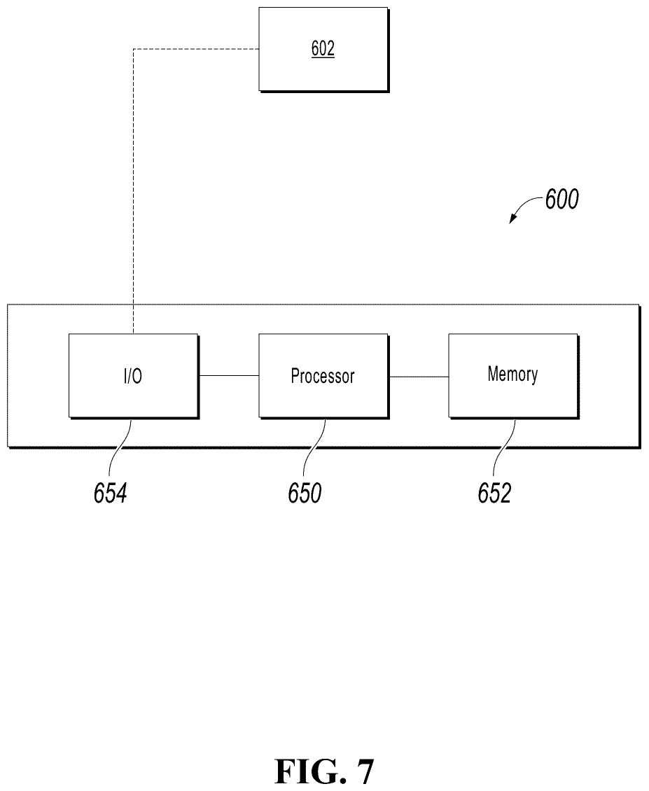

The determinations described throughout this disclosure can be made and/or produced by a controller 600. Such an example controller is illustrated in FIG. 7. In some implementations, the controller 600 can execute all or part of the method 100. The controller 600 can, among other things, monitor parameters of a system, plant, or industrial asset 602, send signals to actuate and/or adjust various operating parameters of such systems for example, a pump or compressor. As shown in FIG. 6, the controller 600 can include one or more processors 650 and non-transitory computer readable memory storage (e.g., memory 652) containing instructions that cause the processors 650 to perform operations. The processors 650 are coupled to an input/output (I/O) interface 654 for sending and receiving communications with components in the system, including, for example, the industrial mechanical asset 602. In certain instances, the controller 600 can additionally communicate status with and send actuation and/or control signals to one or more of the various system components of the system, as well as other sensors (e.g., pressure sensors, temperature sensors, acoustic sensors, vibration sensors, image sensors and other types of sensors) that provide signals to the system. Other aspects of the method 100 can similarly be performed by the controller with various degrees of autonomy, for example, automatically removing spike, transients, and/or shut-down values within data received from the industrial mechanical asset 602. Alternatively or in addition, a user can adjust various parameters to remove such values.

Certain exemplary implementations will now be described to provide an overall understanding of the principles of the structure, function, manufacture, and use of the systems, devices, and methods disclosed herein. One or more examples of these implementations are illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving a first set of data characterizing an operating parameter of an industrial mechanical asset;
identifying and removing values indicative of transients within the first set of data to produce a second set of data characterizing a steady-state operating parameter of the industrial mechanical asset; and
providing the second set of data to a predictive model.

2. The method of claim 1, wherein identifying and removing values indicative of transients comprises:
identifying a state of the mechanical industrial asset over a time period matching the first set of data;
identify transient values within the first set of data indicative of a state change; and
removing the identified values indicative of transients.

3. The method of claim 1, further comprising:
identifying values within the first set of data that correspond to a shut-down state; and
removing the identified values from the first set of data.

4. The method of claim 1, further comprising:
receiving the second set of data by the predictive model; and
predicting health of the industrial mechanical asset based upon the predictive model.

5. The method of claim 1, wherein identifying and removing values indicative of transients comprises:
normalizing the first set of data;
smoothing the first set of data;
creating a lagged version of the first set of data, the lagged version having a time-offset in comparison to the first set of data;
calculating a percentage change between the first set of data and the lagged version;
clustering values within the first set of data into clusters based on the calculated percentage change between the first set of data and the lagged version; and
identifying clusters that include transient values based on the percentage change exceeding a specified threshold.

6. The method of claim 5, further comprising:
determining a silhouette score for each cluster; and
identify a number of steady states based upon the determined silhouette scores.

7. The method of claim 1, wherein providing the second set of data to a predictive model comprises training the predictive model with the second set of data.

8. A system comprising:
at least one data processor; and
non-transitory memory storing instructions, which, when executed by the at least one data processor causes the at least one data processor to perform operations comprising:
receiving a first set of data characterizing an operating parameter of an industrial mechanical asset;
identifying and removing values indicative of transients within the first set of data to produce a second set of data characterizing a steady-state operating parameter of the industrial mechanical asset; and
providing the second set of data to a predictive model.

9. The system of claim 8, wherein identifying and removing values indicative of transients comprises:
identifying a state of the mechanical industrial asset over a time period matching the first set of data;
identify transient values within the first set of data indicative of a state change; and
removing the values indicative of transients.

10. The system of claim 8, wherein the non-transitory memory stores instructions to cause the data processor to further perform operations comprising:
identifying values within the first set of data that correspond to a shut-down state; and
removing the identified values from the first set of data.

11. The system of claim 8, wherein the non-transitory memory stores instructions to cause the data processor to further perform operations comprising:
receiving the second set of data by the predictive model; and
predicting health of the industrial mechanical asset based upon the predictive model.

12. The system of claim 8, wherein identifying and removing values indicative of transients comprises:
normalizing the first set of data;
smoothing the first set of data;
creating a lagged version of the first set of data, the lagged version having a time-offset in comparison to the first set of data;
calculating a percentage change between the first set of data and the lagged version;
clustering values within the first set of data into clusters based on the calculated percentage change between the first set of data and the lagged version; and
identifying clusters that include transient values based on the percentage change exceeding a specified threshold.

13. The system of claim 12, wherein the non-transitory memory stores instructions to cause the data processor to further perform operations comprising:
determining a silhouette score for each cluster; and
identify a number of steady states based upon the determined silhouette scores.

14. The system of claim 8, wherein providing the second set of data to a predictive model comprises training the predictive model with the second set of data.

15. A non-transitory computer readable memory storing instructions which, when executed by at least one data processor forming part of at least one computing system, causes the at least one data processor to perform operations comprising:
receiving a first set of data characterizing an operating parameter of an industrial mechanical asset;
identifying and removing values indicative of transients within the first set of data to produce a second set of data characterizing a steady-state operating parameter of the industrial mechanical asset; and
providing the second set of data to a predictive model.

16. The non-transitory computer readable memory of claim 15, wherein identifying and removing values indicative of transients comprises:
identifying a state of the mechanical industrial asset over a time period matching the first set of data;
identify transient values within the first set of data indicative of a state change; and
removing the values indicative of transients.

17. The non-transitory computer readable memory of claim 15, wherein the instructions further instruct the at least one data processor to perform operations further comprising:
identifying values within the first set of data that correspond to a shut-down state; and
removing the identified values from the first set of data.

18. The non-transitory computer readable memory of claim 15, wherein the instructions further instruct the at least one data processor to perform operations further comprising:
receiving the second set of data by the predictive model; and
predicting health of the industrial mechanical asset based upon the predictive model.

19. The non-transitory computer readable memory of claim 15, wherein identifying and removing values indicative of transients comprises:
normalizing the first set of data;
smoothing the first set of data;
creating a lagged version of the first set of data, the lagged version having a time-offset in comparison to the first set of data;
calculating a percentage change between the first set of data and the lagged version;
clustering values within the first set of data into clusters based on the calculated percentage change between the first set of data and the lagged version; and
identifying clusters that include transient values based on the percentage change exceeding a specified threshold.

20. The non-transitory computer readable memory of claim 19, wherein the instructions further instruct the at least one data processor to perform operations further comprising:
determining a silhouette score for each cluster; and
identify a number of steady states based upon the determined silhouette scores.
